(19) United States
(12) Patent Application Publication
(10) Pub. No.: US 2014/0186597 A1
(43) Pub. Date: Jul. 3, 2014

(54) ADHESIVE TAPE

(71) Applicant: HON HAI PRECISION INDUSTRY CO., LTD., New Taipei (TW)

(72) Inventors: MING-JEN CHANG, New Taipei (TW); CHANG-CHIN WU, New Taipei (TW)

(73) Assignee: HON HAI PRECISION INDUSTRY CO., LTD., New Taipei (TW)

(21) Appl. No.: 14/106,767

(22) Filed: Dec. 15, 2013

(30) Foreign Application Priority Data
Dec. 27, 2012 (TW) 101150712

(51) Int. Cl. C09J 7/02

(52) U.S. Cl. CPC C09J 7/021
USPC 428/214; 428/354; 428/337; 428/339

(57) ABSTRACT

An adhesive tape includes a first adhesive layer and a pair of second adhesive layers respectively formed on two opposite surfaces of the first adhesive layer. The second pressure sensitive adhesive layers are pressure sensitive adhesive layers which provide initial adhesion. The second adhesive layer can be lifted and reused many times, so the final location of the adhesive tape is made correctly and accurately. The adhesive tape is cured to full bond strength by heating only once.

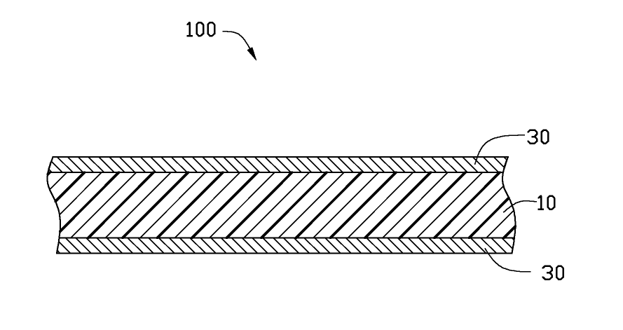

### BACKGROUND

1. Technical Field

The present disclosure relates to adhesives and particularly to adhesive tape.

2. Description of Related Art

Adhesives are widely used in electronic products. Electronic products are thinner and lighter by using the adhesives to fix devices together. Moreover, the adhesives are easy to use and have high bonding strength. The conventional adhesive tapes include thermosetting or thermoplastic adhesives. In use, the adhesive tape is preheated and adhered to a first workpiece. Then, a second workpiece is pasted to the other surface of the adhesive tape. Finally, the adhesive tape is heated to be cured completely, thereby the first workpiece and the second workpiece are bonded together. However, the adhesive tape need to be heated twice, and when the adhesive tape is adhered to the first workpiece or the second workpiece, it cannot be corrected if not initially positioned on the right location. Therefore, the conventional adhesive tapes are not optimal in use.

Therefore, there is room for improvement in the art.

### BRIEF DESCRIPTION OF THE DRAWINGS

The components in the drawing are not necessarily drawn to scale, the emphasis instead being placed upon clearly illustrating the principles of the present disclosure.

The FIGURE is a cross-sectional view of an adhesive tape according to one embodiment of the present disclosure.

### DETAILED DESCRIPTION

The FIGURE shows an adhesive tape 100. The adhesive tape 100 includes a first adhesive layer 10 and two second adhesive layers 30 adhered on two opposite surfaces of the first adhesive layer 10. The first adhesive layer 10 is a thermosetting or thermoplastic adhesive layer, and the second adhesive layers 30 are pressure sensitive adhesive layers. The first adhesive layer 10 comprises at least one compound selected from a group consisting phenolic resin and nitrile rubber compound, polyurethane, polyolefin polymer or any combination of the above materials. The thickness of the first adhesive layer 10 is in a range of about 10 micrometers (μm) to 300 μm. The second adhesive layer 30 comprises at least one compound selected from a group consisting of polymethyl methcrylate, rubber, polyurethane, organic silicon resin, or any combination of the above materials. The thickness of the second adhesive layer 30 is in a range of about 0.1 μm to about 10 μm. The second adhesive layers 30 have a property of initial adhesion which is less than full adhesion. The second adhesive layers 30 are configured for adhering to the surface of a workpiece, and can be repositioned before being cured through heating.

In a first embodiment, the first adhesive layer 10 is made of the compound of phenolic resin and nitrile rubber, the thickness of the first adhesive layer 10 is about 1.0 μm. The initial adhesive force is 50 g/in. The adhesive tape 100 is cut to a rectangular shape with a length of 1 cm and a width of 1 cm, and then adhered between two stainless steel plates. The curing temperature for full strength is 150° C., and the pressing time is 15 minutes (15 min). After that, a pullout test is applied. The test shows that the shear force of the adhesive tape 100 is 250 Kg/cm².

A second embodiment is almost same as the first embodiment, the difference is that the curing temperature is 135° C. The pullout test shows that the shear force of the adhesive tape 100 is then 220 Kg/cm².

In a third embodiment, the first adhesive layer 10 of the adhesive tape 100 is made of the compound of phenolic resin and nitrile rubber, the thickness of the first adhesive layer 10 is about 120 μm. The initial adhesive force is 65 g/in. The adhesive tape 100 is cut to a rectangular shape with a length of 1 cm and a width of 1 cm, and then the adhesive tape 100 is adhered between two stainless steel plates. The curing temperature is 150° C., and the pressing time is 30 min. After that, a pullout test is applied. The test shows that the shear force of the adhesive tape 100 is 180 Kg/cm².

In a fourth embodiment, the first adhesive layer 10 of the adhesive tape 100 is made of the compound of phenolic resin and nitrile rubber, the thickness of the first adhesive layer 10 is about 120 μm. The second adhesive layer 30 is made of polymethyl methacrylate. The thickness of the second adhesive layer 30 is about 3.0 μm. The initial adhesive force is 70 g/in. The adhesive tape 100 is cut to a rectangular shape with a length of 1 cm and a width of 1 cm, and then the adhesive tape 100 is adhered between two stainless steel plates. The curing temperature is 150° C., and the pressing time is 30 min. After that, a pullout test is applied. The test shows that the shear force of the adhesive tape 100 is 120 Kg/cm².

In a fifth embodiment, the first adhesive layer 10 of the adhesive tape 100 is made of composition of phenolic resin and nitrile rubber, the thickness of the first adhesive layer 10 is about 120 μm. The second adhesive layer 30 is made of polymethyl methacrylate. The thickness of the second adhesive layer 30 is about 3.0 μm. The initial adhesive force is 70 g/in. The adhesive tape 100 is cut to a rectangular shape with a length of 1 cm and a width of 1 cm, and then the adhesive tape 100 is adhered between two stainless steel plates. The curing temperature is 165° C., and the pressing time is 30 min. After that, a pullout test is applied. The test shows that the shear force of the adhesive tape 100 is 105 Kg/cm².

In a sixth embodiment, the first adhesive layer 10 of the adhesive tape 100 is made of the compound of phenolic resin and nitrile rubber, the thickness of the first adhesive layer 10 is about 120 μm. The second adhesive layer 30 is made of polymethyl methacrylate. The thickness of the second adhesive layer 30 is about 8.0 μm. The initial adhesive force is 75 g/in. The adhesive tape 100 is cut to a rectangular shape with a length of 1 cm and a width of 1 cm, and then the adhesive tape 100 is adhered between two stainless steel plates. The curing temperature is 120° C., and the pressing time is 30 min. After that, a pullout test is applied. The test shows that the shear force of the adhesive tape 100 is 60 Kg/cm².

A seventh embodiment is almost same as the sixth embodiment, the difference is that the curing temperature is 90° C. The pullout test shows that the shear force of the adhesive tape 100 is 45 Kg/cm².

The adhesive tape 100 of this disclosure includes two second adhesive layers 30 which provide initial adhesion for locational convenience, and the second adhesive layer 30 can be lifted and reused many times, so the final location of the adhesive tape 100 is made correctly and accurately. The adhesive tape 100 is cured to full bond strength by heating only once.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An adhesive tape, comprising:
a first adhesive layer which is a thermosetting or thermoplastic adhesive layer; and
two second adhesive layers formed on two opposite surfaces of the first adhesive layer, wherein the two second adhesive layers are pressure sensitive adhesive layers and provide initial adhesion.

2. The adhesive tape as claimed in claim 1, wherein a thickness of the first adhesive layer is in a range from about 10 μm to about 300 μm.

3. The adhesive tape as claimed in claim 2, wherein a thickness of the first adhesive layer is in a range from about 100 μm to about 120 μm, and a thickness of the second adhesive layer is in a range from about 1.0 μm to about 8.0 μm.

4. The adhesive tape as claimed in claim 1, wherein a thickness of the second adhesive layer is in a range from about 0.1 μm to about 10 μm.

5. The adhesive tape as claimed in claim 1, wherein the first adhesive layer comprises at least one compound selected from a group consisting phenolic resin and nitrile rubber compound, polyurethane, polyolefin polymer or any combination of the above materials.

6. The adhesive tape as claimed in claim 1, wherein the second adhesive layer comprises at least one compound selected from a group consisting of polymethyl methcrylate, rubber, polyurethane, organic silicon resin or any combination of the above materials.
